(19) United States
(12) Patent Application Publication
(10) Pub. No.: US 2024/0276079 A1
(43) Pub. Date: Aug. 15, 2024

(54) Engagement System and Analytical Database for Connected Television

(71) Applicant: Google LLC, Mountain View, CA (US)

(72) Inventors: Riley James Huffman, Santa Monica, CA (US); William Frazier Pierpont Grose, Los Angeles, CA (US); Brendan Khoi Luu, San Francisco, CA (US); Dennis Tseng, Los Angeles, CA (US); Daniel David Dubats, Los Angeles, CA (US)

(21) Appl. No.: 18/013,373

(22) PCT Filed: Nov. 14, 2022
(86) PCT No.: PCT/US2022/049812

§ 371 Date: Dec. 28, 2022

(51) Int. Cl. H04N 21/858; H04N 21/41; H04N 21/4223; H04N 21/4722; H04N 21/478; H04N 21/81

(52) U.S. Cl. CPC H04N 21/858; H04N 21/4126; H04N 21/4223; H04N 21/4722; H04N 21/47815; H04N 21/8173

(57) ABSTRACT

Techniques for improving user experience with connected televisions are described. A computing system (e.g., server) can transmit a video content associated with a product to a connected television (CTV). The video content can include a code (e.g., QR code) that is scannable. Additionally, the system can receive, from a user device of a user, an indication that the user has scanned the code. Moreover, the system can determine, using a mapping database, that the user device is associated with the CTV. For example, the mapping database can indicate that the user is associated with the CTV and the user device. Furthermore, in response to determining that the user device is associated with the CTV, the system can transmit instructions to modify the video content to the CTV.

### FIELD

The present disclosure relates generally to the field of improving user experience with connected televisions. More particularly, the present disclosure relates to using an engagement system to improve user interactions with a connected television and maintaining an analytical database to better measure the user interactions.

### BACKGROUND

A connected television (CTV) can be a television (TV) that streams video over the internet. In one example, the CTV can include an over-the-top (OTT) device that connects to a television to support video content streaming. The OTT device can plug into the television using one of the physical inputs (e.g., HDMI port) of the television. The OTT device enables apps and video streaming to be displayed on the television even when the television is not a smart TV. In another example, the CTV can be a smart TV that includes a device embedded in the television to support video content streaming. The video content can be streamed by using apps that are downloaded. In yet another example, the CTV can be a gaming console. The gaming console can be a connected device to the TV. The gaming console can utilize a built-in app store for streaming video content on a television.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for improving interactions with a connected television (CTV). The method can include transmitting, by a server having one or more computing devices, a video content associated with a product to the CTV. The video content can include a code that is scannable. For example, the code can be a QR code. Additionally, the method can include receiving, from a user device of a user, an indication (e.g., notification) that the user has scanned the code. Moreover, the method can include determining, using a mapping database, that the user device is associated with the CTV. The mapping database can indicate that the user is associated with the CTV and the user device. In response, determining that the user device is associated with the CTV, transmitting, by the server to the CTV, instructions to modify the video content.

In some instances, the instructions to modify the video content can include a message to skip the video content.

In some instances, in response to receiving the indication, the method can include displaying on a display of the user device, a website associated with the product. The website can be managed by a third-party associated with the product.

In some instances, in response to receiving the indication, the method can include displaying on a display of the user device a link to download a third-party application associated with the product.

In some instances, in response to receiving the indication, the method can include displaying on a display of the user device an intermediary interface associated with the product. The intermediary interface can be managed by the server. For example, the intermediary interface can be a user device graphical user interface (GUI) displayed on the user device that is linked to a CTV graphical user interface (GUI) displayed on the CTV. Additionally, a user action performed on the user device GUI can result in a related action being taken on the CTV GUI.

In some instances, the user device can be a mobile device, and the code can be scanned by a camera of the mobile device.

In some instances, the code can include analytical information. For example, the

analytical information can include a title of a show (e.g., movie, television series, sporting event) displayed on the CTV prior to the video content being displayed.

In some instances, the indication received from the user device does not include any personal identifiable information (PII). For example, the indication received from the user device does not include an IP address associated with the user device.

According to some embodiments, the method can further include maintaining, by the server, a database of metrics. For example, the metrics can include a scan metric associated with the code. Additionally, the method can include updating the scan metric associated with the code based on the indication that the user has scanned the code. For example, the scan metric can include a number of scans associated with the code. Moreover, the method can further include transmitting, by the server, information from the scan metric to a third-party associated with the product. Furthermore, the method can include updating, based on the mapping database indicating that the user is associated with the CTV and the user device, the scan metric associated with the code to include information associated with the CTV, the user device, and the user.

According to some embodiments, the metrics can include a purchase metric associated with the code, and the method can further include displaying, on a display of the user device, an option to purchase the product in response to receiving the indication that the user has scanned the code. Additionally, the method can include determining, based on a user input, that the product has been purchased by the user. Moreover, the method can include updating the purchase metric associated with the code based on the determination that the product has been purchased, the purchase metric including a number of purchases associated with the code.

Another example aspect of the present disclosure is directed to a computing system having one or more processors, and one or more non-transitory computer-readable media that collectively store instructions. The instructions, when executed by the one or more processors, cause the computing system to perform operations. The operations can include transmitting a video content associated with a product to a connected television (CTV). The video content can include a code that is scannable. Additionally, the operations can include receiving, from a user device of a user, an indication that the user has scanned the code. Moreover, the operations can include determining, using a mapping database, that the user device is associated with the CTV. The mapping database can indicate that the user is associated with the CTV and the user device. In response to receiving the indication and determining that the user device is associated with the CTV, the operations can further include transmitting instructions to modify the video content to the CTV.

In some instances, the instructions to modify the video content includes a message to skip the video content. Additionally, the indication received from the user device may not include any personal identifiable information (PII).

According to some embodiments, in response to receiving the indication, the operations can further include displaying on a display of the user device an intermediary interface associated with the product. The intermediary interface can be managed by the server.

According to some embodiments, the operations can further include maintaining, by the server, a database of metrics. For example, the metrics can include a scan metric associated with the code. Additionally, the operations can include updating the scan metric associated with the code based on the indication that the user has scanned the code. The scan metric can include a number of scans associated with the code. Moreover, the operations can include transmitting, by the server, information from the scan metric to a third-party associated with the product.

According to some embodiments, the operations can further include updating, based on the mapping database indicating that the user is associated with the CTV and the user device, the scan metric associated with the code to include information associated with the CTV, the user device, and the user.

Another example aspect of the present disclosure is directed to one or more non-transitory computer-readable media that collectively store instructions that, when executed by one or more processors, cause the one or more processors to perform operations. The operations include transmitting a video content associated with a product to a connected television (CTV). The video content can include a code that is scannable. Additionally, the operations can include receiving, from a user device of a user, an indication that the user has scanned the code. Moreover, the operations can include determining, using a mapping database, that the user device is associated with the CTV. The mapping database can indicate that the user is associated with the CTV and the user device. In response to receiving the indication or determining that the user device is associated with the CTV, the operations can further include transmitting instructions to modify the video content to the CTV.

Other aspects of the present disclosure are directed to various systems,

apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system according to example embodiments of the present disclosure.

FIG. 2 depicts a block diagram of an interaction between a connected television and a mobile device according to example embodiments of the present disclosure.

FIG. 3 depicts a flow chart diagram of an example method to perform according to example embodiments of the present disclosure.

FIG. 4 depicts a flow chart diagram of an example method to perform according to example embodiments of the present disclosure.

FIG. 5 is a block diagram of a computing system, according to an illustrative implementation.

Reference numerals that are repeated across plural figures are intended to identify the same features in various implementations.

### DETAILED DESCRIPTION

### Overview

Techniques for improving user experience with connected televisions are described herein. An engagement system (e.g., computing system, cloud server) can transmit a video content associated with a product to a connected television (CTV). The video content can include a code (e.g., QR code) that is scannable. In response to the code being scanned by a camera of a user device, a website associated product can be launched on a web browser of the user device. Additionally, the system can receive, from the user device of the user, an indication that the user has scanned the code. Moreover, the system can determine, using a mapping database, that the user device is associated with the CTV. For example, the mapping database can indicate that the user is associated with the CTV and the user device. Furthermore, in response to determining that the user device is associated with the CTV, the system can transmit instructions to modify (e.g., skip) the video content to the CTV.

In some implementations, the system can generate media content (e.g., movie, video content) on a connected television (CTV) device. As previously mentioned, the CTV can be a smart television (TV) with a graphical user interface to receive user input. Alternatively, the CTV can be a TV with an OTT device or a TV that is connected to a gaming console. In some instances, a user can view a video content associated with a product on the CTV.

According to some embodiments, the engagement system enables a user to navigate to a site (e.g., website, app) maintained by a third-party, and informs the third-party that the user has navigated to the site by scanning a QR code presented on the CTV. For example, the CTV can be playing content video associated with a product, and the content video can include a QR code. Once the QR code is scanned by the mobile device of the user, the link embedded in the QR code can launch a website on the mobile device of the user. The website can be maintained by the cloud server (e.g., digital content server), and then the cloud server can redirect the link to a website that is maintained by the third-party. By first launching the website maintained by the cloud server allows the cloud server to maintain accurate analytical data (e.g., number of QR codes scanned by users) associated with the QR code.

In some instances, the video content can include a code (e.g., QR code) that is scannable by a user device. While viewing the content video, the user can have the option to skip the content video by scanning the code using a user device. The user can scan the code from the CTV by using a camera of the user device. Based on a user input, such as using a mobile device to scan the QR code, the user can access a site (e.g., website, mobile app, intermediary site) associated with the product on the mobile device. Once the code is scanned from the CTV, the user device can be presented with a website associated with the product. Alternatively, the user device can be presented with a mobile app associated with the product. In yet another example, the user device can be presented as an intermediary site that is maintained by the server.

By using a mapping database, the system is able to determine that the CTV and the mobile device are linked to the user without any personal identifiable information (PII) data. In contrast, in conventional systems, the conventional system requires personal identifiable information (PII) data (e.g., IP address of a user) to connect to a second device in the room, such as the mobile device of the user. Further, linking the CT and the mobile device to the user means that any content tailored for the user can be transmitted directly to the mobile device of the user. This allows the correct recipient to receive the intended content. In turn, this reduces overhead associated with transmitting content to an unintended recipient, such as network bandwidth, server resources, and recipient device resources such as memory and battery etc. Additional technical improvements include improving network efficiencies by using the mapping database to authenticate, synchronize, and link the user device with the CTV. As mentioned, by linking both the user device and the CTV with the user, and automatically synchronizing the CTV and the user device without additional authentication steps allows for a more efficient network. For example, the automatic authentication using the mapping database reduces the number of packets being transmitted over the network between the user device and the CTV in order to authenticate and synchronize with each other.

Based on an indication that the website associated with the product has been launched on the user device, the engagement system can transmit a skip notification to the CTV to skip the video content. Additionally, the engagement system can include a server (e.g., ad server) that informs the third-party associated with the product (e.g., manufacturer of the product) that the user has accessed the website based on the content video playing on the CTV.

In some instances, when the code is scanned by a user, the user device can launch an intermediary site. The intermediary site can be an intermediary companion page hosted by a content server of the engagement system, instead of a third-party site maintained by the third-party (e.g., manufacturer) associated with the product. Additionally, the intermediary site can include interactive features for the third-party that may not be available on the site maintained by the third party. Moreover, the intermediary site can include a graphical user interface that is controllable from the user device of the user. For example, the user device can present the graphical user interface having a skip button that enables the content video to be skipped based on a user tapping on the skip button. Furthermore, the graphical user interface can include a plurality of products that are associated with the code scanned from the CTV. The intermediary site can be a secondary engagement screen in addition to the CTV.

The content server hosting the intermediary site can generate better analytical data (e.g., conversion attribution) in comparison of user interactions on third-party sites. By providing improved analytical data, organizations can make more informed decisions with regards to allocation of resources. For example, the content server can determine conversion attribution on the device and be able to link the exposure of a user to a content video that was displayed on a CTV. In contrast, using conventional systems, organizations are not able to determine how many QR scans or website visits have occurred based on a presentation of a QR code in a content video. Additionally, the techniques described herein are able to generate accurate analytical data (e.g., the attribution of the website and/or purchase based on the QR code scan) without third-party cookies.

The techniques described herein enhance user privacy by protecting PII data, given that the process can be implemented without the transmission of PII data between devices. Additionally, the third-party associated with the product that is played in the content video on the CTV can have accurate analytical data (e.g., conversion rate of the content video) associated with user engagement of the content video. Moreover, the user experience is improved by allowing the user to modify (e.g., skip) the content video based on a user-initiated action.

The engagement system enables a user to easily perform an action (e.g., calling a phone number, installing an application, or visiting a website) by scanning the code of the video content. The engagement system allows for the video content to become more interactive with the user by rewarding the user for completing an action (e.g., scanning the code). The reward, in some instances, can be to skip a content video and go back to the prior content (e.g., movie, show) showing on the CTV.

### Example Devices and Systems

In situations in which the systems discussed here collects personal information about users and/or entities, or may make use of personal information, the users and/or entities are provided with an opportunity to control whether programs or features collect user information and/or entity information (e.g., information about a user's social network, social actions or activities, profession, a user's preferences, or a user's current location), or to control whether and/or how to receive content from the content server that may be more relevant to the user and/or entity. In addition, or in the alternative, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user and/or entity have control over how information is collected about the user and/or entity and used by a content server.

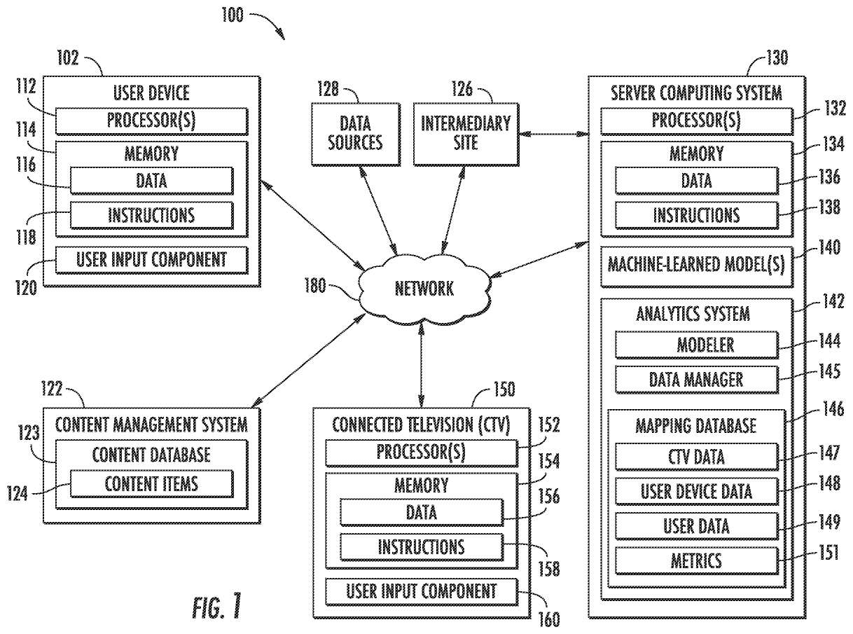

FIG. 1 depicts a block diagram of an example computing system 100 according to example embodiments of the present disclosure. The system 100 includes a user device 102, a server computing system 130, a content management system 122, data sources 128, and content provider devices 126 that are communicatively coupled over a network 180.

The user device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more computer-readable storage media that may be non-transitory, such as RAM, ROM, EEPROM, EPROM, flash memory devices, magnetic disks, etc., and combinations thereof. The memory 114 can store data 116 and instructions 118 which are executed by the processor 112 to cause the user device 102 to perform operations.

The user device 102 can also include one or more user input components 120 that receives user input. For example, the user input component 120 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The user device 102 may be used by a user to perform various actions and/or access various types of content, some of which may be provided over a network 180. The user device 102 may be used to send data to the server computing system 130, or may be used to access websites (e.g., using an internet browser), media files, and/or any other types of content. In some implementations, the user device 102 has enabled location services which can be tracked over network 180. Location services may use GPS or other technologies to determine a location of user device 102.

The content management system 122 may be configured to select content for display to users within resources (e.g., webpages, applications) and to provide content items to the user device 102 and/or connected television 150 over the network 180 for display within the resources. The content from which the content management system 122 selects items may be provided by one or more content providers via the network 180. In some implementations, the content management system 122 may select content items from content providers to be displayed on the user device 102. In some implementations, the content management system 122 may select content items from content providers to be displayed on the CTV 102. In such implementations, the content management system 122 may determine content to be published in one or more content interfaces of resources (e.g., webpages, applications).

In some instances, the server computing system 130 can interact with an intermediary site 126 to select content for display to users. For example, the intermediary site 126 can be a website maintained or hosted by the server computing system 130.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more computer-readable storage media that may be non-transitory, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

In some implementations, the server computing system 130 can store or otherwise include one or more models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some implementations, the server computing system 130 can store or otherwise include an analytics system 142. For example, the analytics system 142 can include a modeler 144, a data manager 145, and a mapping database 146. The mapping database 146 can include a CTV database 147, a user device database 148, and a user database 149. For example, the mapping database 146 can link a user to one or more CTV and one or more user devices based on the relationships between the CTV database 147, the user device database 148, the user database 149, and a metrics database 151. The metrics database 151 can include scan metric data (e.g., number of times a QR code has been scanned, conversion rate) and purchase metric data (e.g., number of times a product has been purchased after the QR code has been scanned).

Data sources 128 may include data collected by the server computing system 130 (e.g., analytics system 142) by receiving interaction data from the intermediary site 126, user device 102, and/or CTV 150. The data may be content input and response for particular media channels (e.g., television, Internet content, radio, billboards, printed publications) at one or more points in time. The data may be data input for particular entities or users (e.g., customer purchases, internet content items). The content input may include data associated with a plurality of entities, a plurality of users, a specific entity, a specific user, and so on. Data sources 126 may also be various data aggregating systems and/or entities that collect content data. The server computing system 130 can receive device data, user data, scan data, and QR code data from the data sources 126 via the network 180. This information may be stored as data 136 and/or as CTV data 147, user device data 148, and user data 149 in the mapping database 146.

The server computing system 130 can train the models 140 via interaction with the CTV 150 that is communicatively coupled over the network 180.

The connected television (CTV) 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more computer-readable storage media that may be non-transitory, such as RAM, ROM, EEPROM, EPROM, flash memory devices, magnetic disks, etc., and combinations thereof. The memory 154 can store data 156 and instructions 158 which are executed by the processor 152 to cause the CTV 150 to perform operations. In some implementations, the CTV 150 includes or is otherwise implemented by one or more server computing devices.

The CTV 150 can also include one or more user input components 160 that receives user input. For example, the user input component 160 can be a touch-sensitive component (e.g., a touch-sensitive display screen or a touch pad) that is sensitive to the touch of a user input object. The touch-sensitive component can serve to implement a virtual keyboard. Other example user input components include a remote, a microphone, a traditional keyboard, or other means by which a user can provide user input.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the analytics system 142 can include a modeler 144, a data manager 145, and a mapping database 146. It should be understood that various implementations may include more, fewer, or different systems than illustrated in FIG. 1, and all such modifications are contemplated within the scope of the present disclosure.

The analytics system 142 may be used by content providers to quantify the impact video content presented on the CTV 150. In various implementations, the analytics system 142 and the content management system 122 in FIG. 1 can be implemented as separate systems or integrated within a single system (e.g., the content management system 122 can be configured to incorporate some or all the functions/capabilities of the analytics system 142). The analytics system 142 may be configured to communicate over network 180 via a variety of architectures (e.g., client/server, peer-to-peer).

The analytics system 142 can be communicably and operatively coupled to the mapping database 146 which may be configured to store a variety of information relevant to generating and determining relationships between the CTV data 147, user device data 148, and user data 149. Additionally, information received from user device 102, content provider device 126, data sources 128, and/or content management system 126 can be stored in the mapping database 146. The analytics system 142 can be configured to query the mapping database 146 for information and store information in the mapping database 146.

In various implementations, the mapping database 146 includes various transitory and/or non-transitory storage mediums. The storage mediums may include but are not limited to magnetic storage, optical storage, flash storage, RAM, etc. The mapping database 146 and/or the analytics system 142 can use various APIs to perform database functions, such as managing data stored in the mapping database 146. The APIs can be but are not limited to SQL, NoSQL, NewSQL, ODBC, JDBC.

Analytics system 142 can be configured to communicate with any device or system shown in computing system 100 via network 180. The analytics system 142 can be configured to receive information from the network 180. The information may include browsing histories, cookie logs, television content data, and/or online content activity data. The analytics system 142 can be configured to receive and/or collect the interactions that the user device 102 has on the network 180. The analytics system 142 can be configured to receive and/or collect the interactions that the CTV 150 has on the network 180.

The analytics system 142 can be configured to generate and send information and/or notifications relating to various metrics or models to a user computing device 102 (e.g., device of content provider). Further, the analytics system 142 can use the various metrics to identify opportune times to send video content to the CTV 150. The analytics system 142 can cause a message to be sent to the content management system 122 and/or the intermediary site 126 indicating that the content management system 122 should contact a certain user at a certain time and/or a content campaign operates with certain parameters.

The data manager 145 can be configured to generate various data structures stored in the mapping database 146. For example, the data manager 145 can be configured to generate one or more relationship graphs. The relationship graphs may be a data structure included in the mapping database 146. For example, the relationship graphs can include nodes associated with unique CTV identifiers mapped to a user. Additionally, the relationship graphs can include nodes associated with unique device identifiers (e.g., MAC address) mapped to a user. Based on the different relationship graphs, the server computing system 130 can determine whether a CTV 150 and a user device 102 are linked to a specific user.

The data manager 145 can also be configured to communicate with content management system 122 via network 180 in order to determine a relationship between a CTV 150, a user device 102, and a specific user. In addition, data manager 145 may be configured to determine one or more characteristics associated with the video content, the show, the CTV 150, the user device 102, and the specific user. Characteristics may include associated keywords used in a search query, title of a show, geographic locations, website views, video views (e.g., via YouTube), content views, content clicks, code scanned.

The data manager 145 can further be configured to retrieve and analyze user activity data including actions performed by user device 102 over network 180. For example, the data manager can analyze user activity data on the intermediary site 126. In some implementations, data manager 145 retrieves user activity data and creates an activity log with one or more log entries. The activity log can span over any specified time period (e.g., past month, past week) and can be specific to users based on any constraints (e.g., watching a first movie). The data manager 145 may be configured to use a filtered activity log to determine a subset of users (i.e., a subset of the users associated with the original activity log). The subset of users may be users that have a likelihood of being exposed to the content items being analyzed.

The mapping database 146 may include subsets of data that each include response data, input data, a content type, control variables, evaluation data, training data, and/or a location identifier associated with video content. The data may be for one or more points in time over an interval (e.g., data for each hour out of a day, data for each day out of a year, data for each month out of a decade). The content type may indicate a particular media channel of the set of data, for example, television. The response data can be a result of an action associated with the input data. In some embodiments, the response can be the number of conversions, number of sales, number of account registrations. The input data may indicate user input in response to viewing the video content.

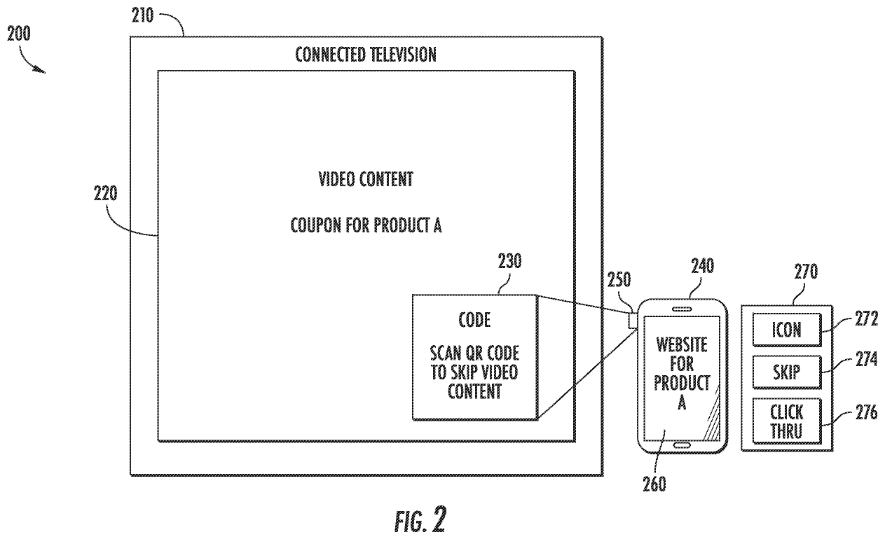

FIG. 2 depicts a block diagram of an interaction 200 between a connected

television and a mobile device according to example embodiments of the present disclosure. According to some embodiments, a connected television 210 (e.g., CTV 150) can present a video content 220 (e.g., advertisement). For example, the video content 220 can be a coupon for product A. In order to improve the user experience, the video content 220 can include a code 230 that is scannable by a user. In this example, a user device 240 having a camera 250 can scan the code 230. Once the code 230 is scanned, a website associated with product A can be displayed on a display 260 of the user device. Additionally, in response to the code 230 being scanned, the video content 220 that is displayed on the connected television 210 can be skipped.

Alternatively, in some embodiments, the option to skip the video content 220 can be presented on the user device 240. In some instances, after the code 230 displayed on the connected television 210 is scanned by the user device 240, the display of the user device 240 can present a graphical user interface 270 (e.g., with a skip button 274) that enables the user to skip the video content. For example, a user can press (e.g., interact, touch) the skip button 274 displayed on the user device 240 to skip the video content 220 displayed on the connected television 210.

According to the implementations, the user device 240 can include a companion application having a graphical user interface 270. The companion application can enable the user device 240 to transmit commands to the connected television 210. In some embodiments, the commands can be transmitted directly (e.g., via Bluetooth). In some other embodiments, the user device 240 (e.g., user device 102) can transmit commands to the server computing system 130 over network 180, and the server computing system 130 can subsequently transmit instructions to the connected television 210 (e.g., connected television 150).

In some instances, the companion application can be downloaded by a user from an app store. For example, the first time that a user scans the code 230, a link can be provided on the user device 240 to download the companion application. Once the companion application is installed on the user device 240, the user can interact directly with the connected television 210 by using the companion application. The companion application can include a graphical user interface 270 having interaction buttons. As described in FIG. 2, the graphical user interface 270 can include an icon button 272, a skip button 274, a chick-thru button 276, and any other button that can allow the user to interact with video content 220 and/or the connected television 210. By interacting with the different buttons (e.g., icon button 272, skip button 274, chick-thru button 276) the user device 240 can easily and quickly provide feedback to the connected television 210.

### Example Methods

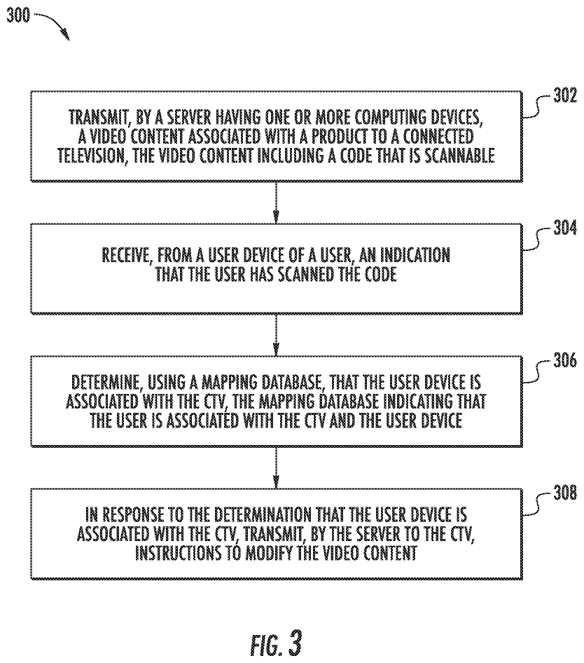

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of method 300 can be omitted, rearranged, combined, and/or adapted in various ways without deviating from the scope of the present disclosure.

At 302, a computing system can transmit a video content associated with a product to a connected television (CTV). The computing system can be a server (e.g., server computing system 130 in FIG. 1) having one or more computing devices. The CTV can be the connected television 150 in FIG. 1. Additionally, as described in FIG. 2, the video content 220 can include code 230 that is scannable.

In some instances, the code at 302 can be a QR code. Additionally, the code can include analytical information. For example, the analytical information can include a title of a show (e.g., title of a movie, title of a TV series, title of a sporting event, title of a news show) presented on the CTV prior to the video content being presented.

At 304, the computing system can receive, from a user device of a user, an indication that the user has scanned the code. In some instances, the indication can be transmitted by user device 102 can scan the code (e.g., code 230 in FIG. 2). The code can include a link (e.g., Uniform Resource Locator (URL)) that opens a webpage on the user device 102. The webpage can be maintained by the computing system. Additionally, the link can include information that informs the computing system that the user device 102 has scanned the code embedded in the video content that is transmitted at 302.

In some instances, the user device at 304 can be a mobile device and the code can be scanned by a camera of the mobile device.

In some instances, indication received from the user device at 304 does not include any personal identifiable information (PII). For example, the indication received from the user device does not include an IP address associated with the user device.

According to some implementations, in response to receiving the indication at 304, the computing system can present on a display of the user device, a website associated with the product. The website can be managed by a third-party (e.g., manufacturer) associated with the product. In some instances, the third-party associated with the product can be the owner, manufacturer, or producer of the product. For example, the link embedded in the QR code can direct the user device to a webpage managed (e.g., hosted) by the computing system (e.g., server computing system 130), and that webpage can redirect the user device to a website managed by the third-party associated with the product. By first directing the user device to the webpage managed by the computing system allows the computing system to obtain analytical data (e.g., number of scans, a unique user identifier, a unique CTV identifier, a user device identifier) to store in the analytical database 142.

According to some other implementations, in response to receiving the indication at 304, the computing system can present on a display of the user device a link to download a third-party application associated with the product. For example, the QR code can include a link to a third-party application that is available to be downloaded from an application (‘app’) store.

According to some other implementations, in response to receiving the indication at 304, the computing system can present on a display of the user device an intermediary interface associated with the product. The intermediary interface can be managed by the server. For example, the intermediary site 126 in FIG. 1 can be an example of the intermediary interface that is presented on the display of the user device. In some instances, the intermediary interface can be a user device graphical user interface (GUI) that is linked to a CTV graphical user interface (GUI) presented on the CTV. Additionally, a user action performed on the user device GUI can result in a related action being taken on the CTV GUI. For example, a user can perform an action on the user device GUI and a similar action can also be performed for the CTV GUI.

At 306, the computing system can determine, using a mapping database, that the user device is associated with the CTV. In some instances, the mapping database 146 in FIG. 1 can be utilized to make the determination at 306. The mapping database can indicate that the user is associated with the CTV and the user device. For example, the user can be associated with a unique user identifier, the CTV can be associated with a unique CTV identifier, and the user device can be associated with a user device identifier (e.g., MAC address).

At 308, in response to the determination that the user device is associated with the CTV at 306, the computing system can transmit, to the CTV, instructions to modify the video content. For example, the instructions transmitted at 308 can include a message to skip the video content.

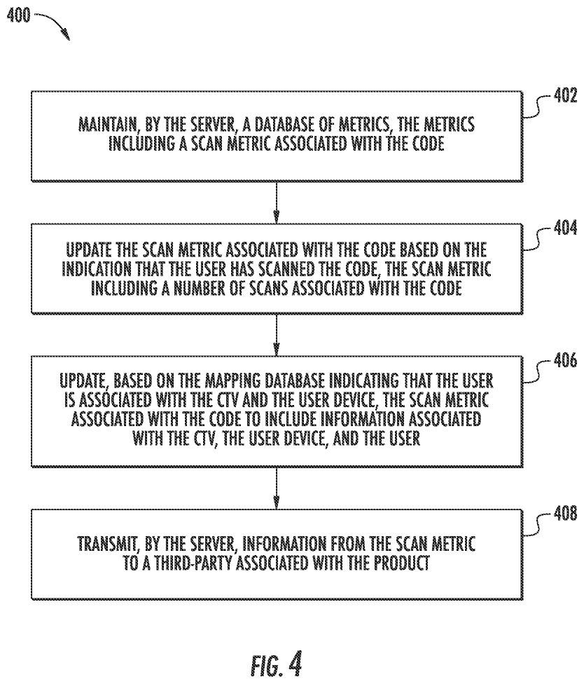

FIG. 4 depicts a flow chart diagram of an example method to perform according to example embodiments of the present disclosure. Although FIG. 4 depicts steps performed in a particular order for purposes of illustration and discussion, the methods of the present disclosure are not limited to the particularly illustrated order or arrangement. The various steps of method 400 can be omitted, rearranged, combined, and/or adapted in various ways without deviating from the scope of the present disclosure.

At 402, a computing system (e.g., server computing system 130) can maintain a database of metrics. The metrics can include a scan metric associated with the code. For example, the analytics system 142 can maintain the database of metrics (e.g., metrics 151).

At 404, the computing system can update the scan metric associated with the code based on the indication that the user has scanned the code. For example, the computing system can receive an indication at 304 that the user has scanned the code. The scan metric updated at 404 can include a number of scans associated with the code.

At 406, the computing system can update the scan metric associated with the code to include information associated with the CTV, the user device, and the user. The scan metric can be updated based on the mapping database (e.g., mapping database 146) indicating that the user is associated with the CTV and the user device. As previously mentioned, the computing system can make a determination at 306 using the mapping database that the user device is associated with the CTV.

At 408, the computing system can transmit information from the scan metric to a third-party associated with the product. For example, the third-party that created the video content that is transmitted at 302 can receive analytical information regarding the performance or effectiveness of the video content.

According to some embodiments, the metrics (e.g., metrics 151) can include a purchase metric associated with the code. Additionally, in response to receiving the indication that the user has scanned the code, the computing system can present on a display of the user device, an option to purchase the product. As previously mentioned, the computing system can receive an indication at 304 that the user has scanned to the code. In some instances, the computing system can present a webpage that allows the user to purchase the product. For example, the user device can transmit a user input (e.g., click to buy) to the computing system to indicate that the user wants to purchase the product. Moreover, the computing system can determine, based on the user input, that the product has been purchased by the user. Furthermore, the computing system can update the purchase metric associated with the code based on the determination that the product has been purchased, the purchase metric including a number of purchases associated with the code.

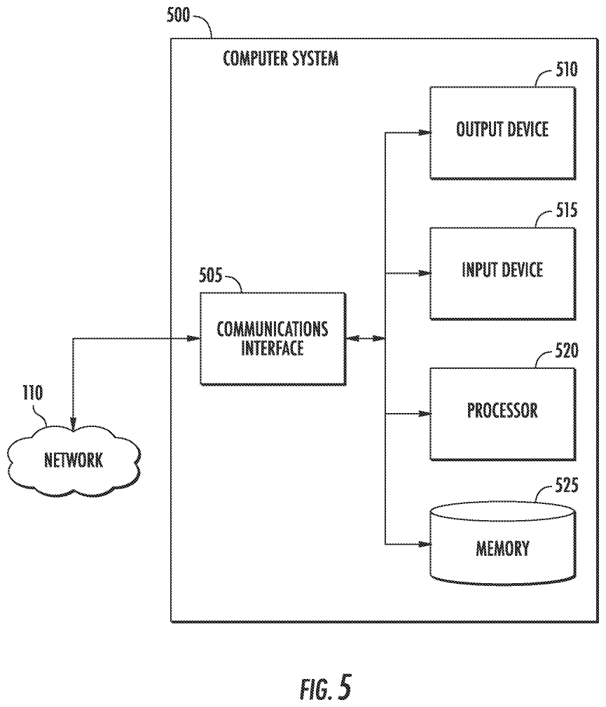

FIG. 5 illustrates a depiction of a computer system 500 that can be used, for example, to implement a user device 102, a content management system 122, a server computing system 130, an analytics system 142, a CTV 150 and/or various other illustrative systems described in the present disclosure. The computing system 500 includes a bus 505 or other communication component for communicating information and a processor 510 coupled to the bus 505 for processing information. The computing system 500 also includes main memory 515, such as a random-access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid-state device, magnetic disk, or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information, and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

In some implementations, the computing system 500 may include a communications adapter 540, such as a networking adapter. Communications adapter 540 may be coupled to bus 505 and may be configured to enable communications with a computing or communications network 130 and/or other computing systems. In various illustrative implementations, any type of networking configuration may be achieved using communications adapter 540, such as wired (e.g., via Ethernet), wireless (e.g., via Wi-Fi, Bluetooth, etc.), pre-configured, ad-hoc, LAN, WAN, etc.

According to various implementations, the processes that effectuate illustrative implementations that are described herein can be achieved by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

### Additional Disclosure

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination. Additionally, features described with respect to particular headings may be utilized with respect to and/or in combination with illustrative implementations described under other headings; headings, where provided, are included solely for the purpose of readability, and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

1. A computer-implemented method for improving interactions with a connected television (CTV), the method comprising:
transmitting, by a server having one or more computing devices, a video content associated with a product to the CTV, the video content including a code that is scannable;
receiving, from a user device of a user, an indication that the user has scanned the code;
determining, using a mapping database, that the user device is associated with the CTV, the mapping database indicating that the user is associated with the CTV and the user device; and
in response to determining that the user device is associated with the CTV, transmitting, by the server to the CTV, instructions to modify the video content.

2. The method of claim 1, wherein the instructions to modify the video content includes a message to skip the video content.

3. The method of claim 1, further comprising:
in response to receiving the indication, displaying on a display of the user device, a website associated with the product, wherein the website is managed by a third-party associated with the product.

4. The method of any preceding claim 1, further comprising:
in response to receiving the indication, displaying on a display of the user device a link to download a third-party application associated with the product.

5. The method of claim 1, further comprising:
in response to receiving the indication, displaying on a display of the user device an intermediary interface associated with the product, wherein the intermediary interface is managed by the server.

6. The method of claim 5, wherein the intermediary interface is a user device graphical user interface (GUI) that is linked to a CTV GUI displayed on the CTV, and wherein a user action performed on the user device GUI results in a related action being taken on the CTV GUI.

7. The method of claim 1, wherein the code is a QR code.

8. The method of claim 1, wherein the user device is a mobile device, and wherein the code is scanned by a camera of the mobile device.

9. The method of claim 1, wherein the code includes analytical information, the analytical information having a title of a show displayed on the CTV prior to the video content being displayed.

10. The method of claim 1, wherein the indication received from the user device does not include any personal identifiable information (PII).

11. The method of claim 10, wherein the indication received from the user device does not include an IP address associated with the user device.

12. The method of claim 1, further comprising:
maintaining, by the server, a database of metrics, the metrics including a scan metric associated with the code;
updating the scan metric associated with the code based on the indication that the user has scanned the code, the scan metric including a number of scans associated with the code; and
transmitting, by the server, information from the scan metric to a third-party associated with the product.

13. The method of claim 12, further comprising:
updating, based on the mapping database indicating that the user is associated with the CTV and the user device, the scan metric associated with the code to include information associated with the CTV, the user device, and the user.

14. The method of claim 12 or 13, wherein the metrics including a purchase metric associated with the code, the method further comprising:
in response to receiving the indication that the user has scanned the code, displaying on a display of the user device, an option to purchase the product;
determining, based on a user input, that the product has been purchased by the user; and
updating the purchase metric associated with the code based on the determination that the product has been purchased, the purchase metric including a number of purchases associated with the code.

15. A computing system, comprising:
one or more processors; and
one or more computer-readable media that collectively store instructions that, when executed by the one or more processors, cause the computing system to perform operations, the operations comprising:
transmitting, by a server having one or more computing devices, a video content associated with a product to the CTV, the video content including a code that is scannable;
receiving, from a user device of a user, an indication that the user has scanned the code;
determining, using a mapping database, that the user device is associated with the CTV, the mapping database indicating that the user is associated with the CTV and the user device; and
in response to determining that the user device is associated with the CTV, transmitting, by the server to the CTV, instructions to modify the video content the method of any preceding claim.

16. (canceled)

17. The computer system of claim 15, wherein the instructions to modify the video content includes a message to skip the video content, and wherein the indication received from the user device does not include any personal identifiable information (PII).

18. The computer system of claim 15, the operations further comprising:
in response to receiving the indication, presenting on a display of the user device an intermediary interface associated with the product, wherein the intermediary interface is managed by the server.

19. The computer system of claim 15, the operations further comprising:
maintaining, by the server, a database of metrics, the metrics including a scan metric associated with the code;
updating the scan metric associated with the code based on the indication that the user has scanned the code, the scan metric including a number of scans associated with the code; and
transmitting, by the server, information from the scan metric to a third-party associated with the product.

20. The computer system of claim 15, the operations further comprising:
updating, based on the mapping database indicating that the user is associated with the CTV and the user device, the scan metric associated with the code to include information associated with the CTV, the user device, and the user.

21. One or more non-transitory computer-readable media that collectively store instructions that, when executed by one or more processors, cause the one or more processors to perform operations comprising:
transmitting a video content associated with a product to a connected television (CTV), the video content including a code that is scannable;
receiving, from a user device of a user, an indication that the user has scanned the code;
determining, using a mapping database, that the user device is associated with the CTV, the mapping database indicating that the user is associated with the CTV and the user device; and
in response to determining that the user device is associated with the CTV, transmitting instructions to modify the video content to the CTV.
